(19) United States
(12) Patent Application Publication
(10) Pub. No.: US 2010/0300010 A1
(43) Pub. Date: Dec. 2, 2010

(54) ECO SPHERE

(76) Inventor: Maria Eugenia Vallejo, Sunny Isles, FL (US)

Correspondence Address: Alcoba & Associates, P.A., Suite 211, 3399 NW 72 Avenue, Miami, FL, 33122, US

(21) Appl. No.: 12/472,619

(22) Filed: May 27, 2009

(51) Int. Cl. B66B 9/00; E04B 1/21; E04C 2/00; E04B 7/10

(52) U.S. Cl. 52/30; 52/741.11; 52/782.1; 52/81.3

(57) ABSTRACT

A dismantable, self sufficient, foundationless, partially subterranean, spherically shaped dwelling unit adapted for human dwelling, comprising inter alia of a dismantable spherical space mesh structural support, comprised of a plurality of nucleus joint and rod systems, a plurality of dismantable floor members comprised of a plurality of nucleus joint and rod systems, a plurality of dismantable wall members comprised of a plurality of nucleus joint and rod systems, a central elevator shaft, an elevator means, a plurality of power generating, means for generating electric power, a water accumulation and purification system, and a plurality of interchangeable service units that allow for a dwelling unit that can be adapted for a variety of different living styles and appearances. As such, the dwelling unit contemplated by the present invention provides a level of variation and owner input that is not currently available in the traditional construction industry.

### BACKGROUND

The present invention relates to spherical dwelling units, specifically a dismantable, self sufficient, foundationless, partially subterranean, spherically shaped dwelling unit adapted for human dwelling.

Despite advances in the construction industry, the technology used in the construction and fabrication of human dwelling units has remained largely unchanged. Generally, the construction and fabrication of traditional human dwelling units involves high material costs, time consuming processes and the need for individuals with specialized knowledge in the field of construction. Moreover, the typical human dwelling unit is a permanent structure that is reliant upon an independent energy and water source that is not readily modifiable or transportable.

Various spherical or dome shaped human dwelling units have been proposed to solve or at least mitigate threats posed in certain geographic areas such as, earthquakes and flooding. Even such modified dwelling units involve similarly high material costs, time consuming processes and the need for individuals with specialized knowledge in the field of construction as found in their traditional dwelling unit counterparts. Additionally the modified dwelling units are no less permanent, self-sufficient or easier to modify or transport when compared to their traditional dwelling unit counterparts.

The present device was invented to address the foregoing problem. Specifically, a dismantable, self sufficient, foundationless, partially subterranean, spherically shaped dwelling unit adapted for human dwelling comprising inter alia of a dismantable spherical space mesh structural support, comprised of a plurality of nucleus joint and rod systems, a plurality of dismantable floor members comprised of a plurality of nucleus joint and rod systems, a plurality of dismantable wall members comprised of a plurality of nucleus joint and rod systems, a central elevator shaft, an elevator means, a plurality of power generating means for generating electric power, a water accumulation and purification system, and a plurality of interchangeable service units.

By constructing the spherical dwelling unit contemplated by the present invention out of a plurality of nucleus joint and rod member systems and incorporating a plurality of power generating means and a water accumulation and purification system therein, the spherical dwelling unit contemplated by the present invention is dismantable, self-sufficient and easily modifiable. The reinforced foundationless, metal spherical construction is resistant to most natural disasters including high winds caused by hurricanes and tornados, earthquakes and even flood or wild fire. Because the dwelling unit contemplated by the present invention is foundationless, said unit is easily transportable if the need to do so arises. Incorporating an independent power and water source allows for the dwelling unit to be self-sufficient and ecologically friendly as it does not rely on a traditional power grid or water supply.

One of the key features of the present invention is that the nucleus joint and rod systems and the interchangeable service units can be assembled without the need of specialized knowledge in the construction field so that virtually anyone can assemble the dwelling unit contemplated by the present invention. The interchangeability of the nucleus joint and rod systems along with the interchangeable service units allows for a dwelling unit that can be adapted for a variety of different living styles and appearances. As such, the dwelling unit contemplated by the present invention provides a level of variation and owner input that is not currently available in the traditional construction industry.

An objective of the present invention is to provide a spherical dwelling unit comprised of a plurality of nucleus joint and rod systems.

Another objective of the present invention is to provide a spherical dwelling unit that can be constructed without a specialized knowledge in the field of construction.

Another objective of the present invention is to provide a spherical dwelling unit that is self sufficient and not dependant on exterior power and water supplies.

Another objective of the present invention is to provide a spherical dwelling unit that can be easily modified.

Yet, a further objective of the present invention is to provide a spherical dwelling unit that can be dismantled and then reassembled at a different location on a later date.

Beckius, U.S. Pat. No. 2,166,577; Noble, U.S. Pat. No. 5,394,661; Clasky et al., U.S. Pat. No. 4,565,149; and Davis, U.S. Pat. No. 4,067,153 all disclose various spherical or dome shaped dwelling units; however each fails to disclose a self-sufficient, dismantable, foundationless spherical dwelling structure comprised essentially of inter alia, a plurality of nucleus joint and rod systems and interchangeable service units.

For the foregoing reasons there exists a need for a dismantable, self sufficient, foundationless, partially subterranean, spherically shaped dwelling unit adapted for human dwelling comprising inter alia of a dismantable spherical space mesh structural support, comprised of a plurality of nucleus joint and rod systems, a plurality of dismantable floor members comprised of a plurality of nucleus joint and rod systems, a plurality of dismantable wall members comprised of a plurality of nucleus joint and rod systems, a central elevator shaft, an elevator means, a plurality of power generating means for generating electric power, a water accumulation and purification system, and a plurality of interchangeable service units.

### SUMMARY

A dismantable, self sufficient, foundationless, partially subterranean, spherically shaped dwelling unit adapted for human dwelling comprising inter alia of a dismantable spherical space mesh structural support, comprised of a plurality of nucleus joint and rod systems, a plurality of dismantable floor members comprised of a plurality of nucleus joint and rod systems, a plurality of dismantable wall members comprised of a plurality of nucleus joint and rod systems, a central elevator shaft, an elevator means, a plurality of power generating means for generating electric power, a water accumulation and purification system, and a plurality of interchangeable service units.

By constructing the spherical dwelling unit contemplated by the present invention out of a plurality of nucleus joint and rod member systems and incorporating a plurality of power generating means and a water accumulation and purification system therein, the spherical dwelling unit contemplated by the present invention is dismantable, self-sufficient and easily modifiable. The reinforced foundationless, metal spherical construction is resistant to most natural disasters including high winds caused by hurricanes and tornados, earthquakes and even flood or wild fire. Because the dwelling unit contemplated by the present invention is foundationless, said unit is easily transportable if the need to do so arises. Incorporating an independent power and water source allows for the dwelling unit to be self-sufficient and ecologically friendly as it does not rely on a traditional power grid or water supply.

One of the features of the present invention is that the nucleus joint and rod systems and the interchangeable service units can be assembled without the need of specialized knowledge in the construction field so that virtually anyone can assemble the dwelling unit contemplated by the present invention. The interchangeability of the nucleus joint and rod systems along with the interchangeable service units allows for a dwelling unit that can be adapted for a variety of different living styles and appearances. As such, the dwelling unit contemplated by the present invention provides a level of variation and owner input that is not currently available in the traditional construction industry.

Another feature of the present invention is that it does not include a foundation, thereby allowing the invention to be transportable and reassembled at different locations. Furthermore, by including a power generating means and water accumulation and purification means, the dwelling unit is environmentally friendly and self-sufficient.

### DRAWINGS

These and other features, aspects, and advantages of the present invention will become better understood with regard to the following description, appended claims and drawings where:

FIG. 1 shows a cross sectional side view of one embodiment of the dwelling unit;

FIG. 2 shows a side elevation view of one embodiment of the dwelling unit with the removably attached skin plates;

FIG. 3 shows a top plan view of one embodiment of the dwelling unit without the removably attached skin plates;

FIGS. 4A-C show the nucleus joint and rod systems of the dwelling unit in various configurations;

FIG. 5 shows one embodiment of the nucleus joint of the dwelling unit;

FIG. 6A-C show nucleus joints and rods removably attached to one and other;

FIG. 7A-B show nucleus joints with several rods removably attached thereto; and

FIGS. 8A-D show top plan views of various floor plans for the dwelling unit.

### DESCRIPTION

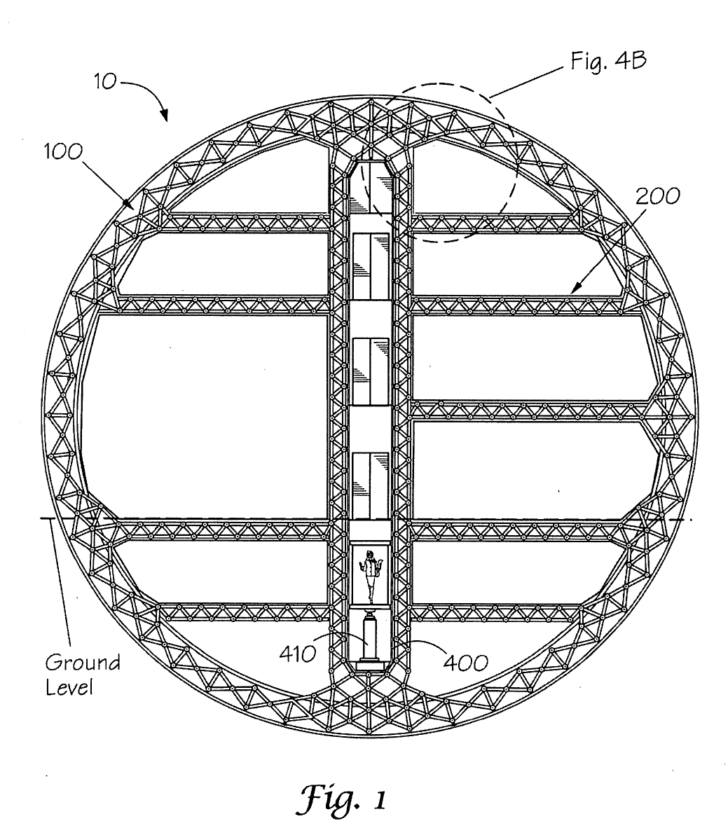

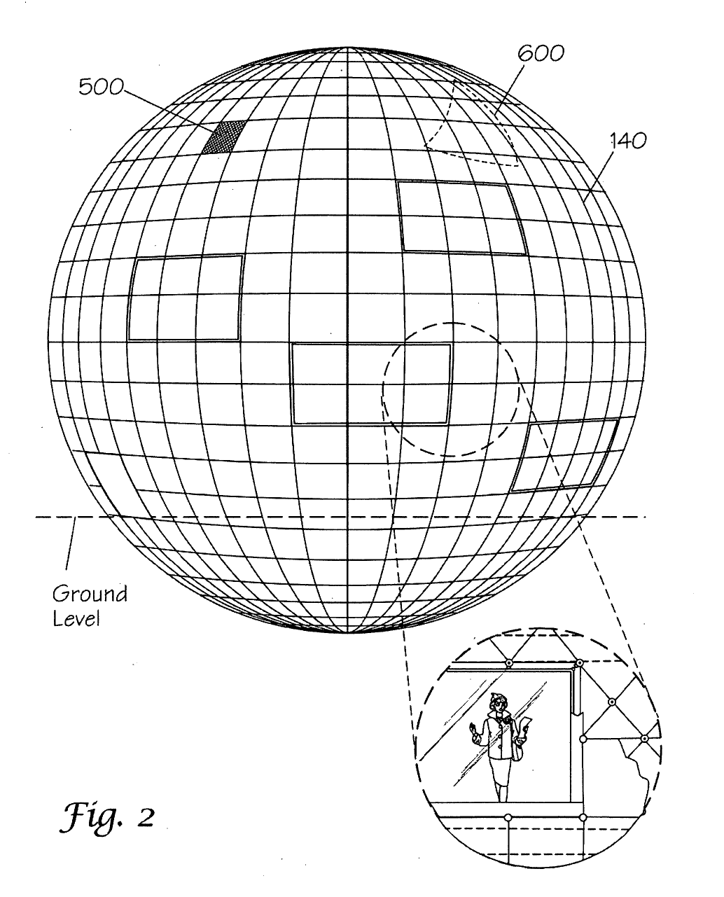

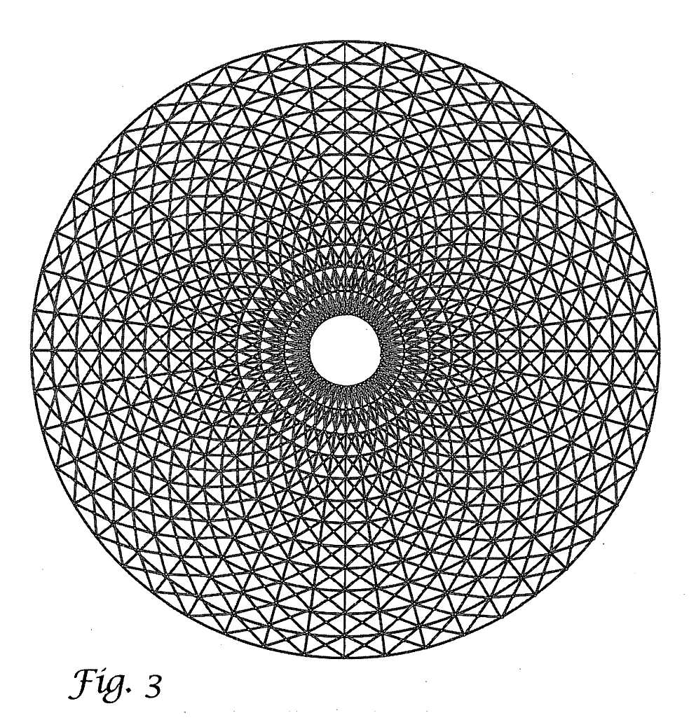

As shown in FIG. 1-3, a dismantable, self sufficient, foundationless, partially subterranean, spherically shaped dwelling unit 10 adapted for human dwelling, the dwelling unit 10 comprising of, inter alia, a dismantable spherical space mesh structural support 100, a plurality of dismantable floor members 200, a plurality of dismantable wall members 300, a central elevator shaft 400, an elevator means 410, a plurality of power generating means 500 for generating electric power, a water accumulation and purification system 600, and a plurality of interchangeable service units 700.

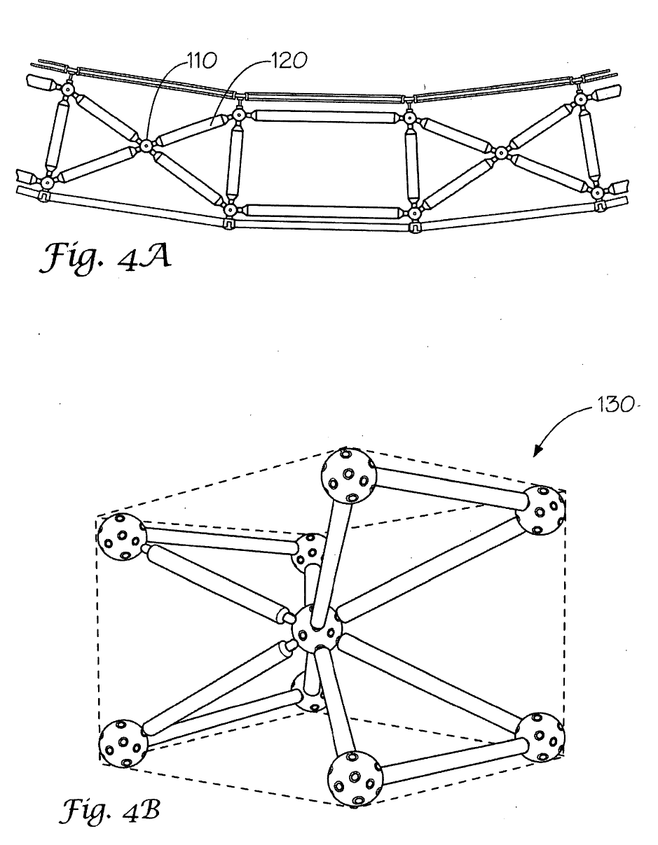

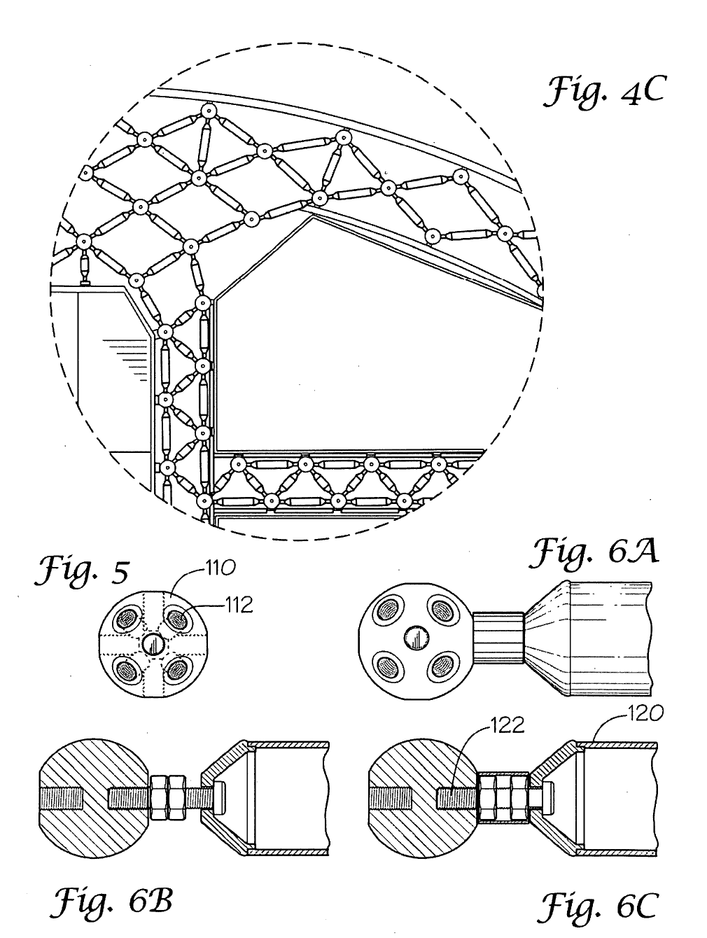

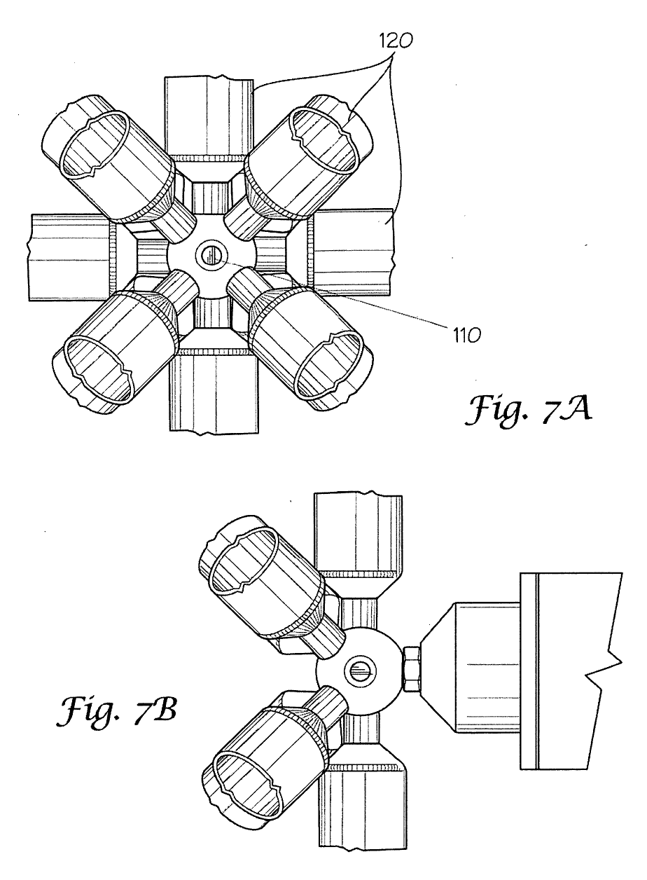

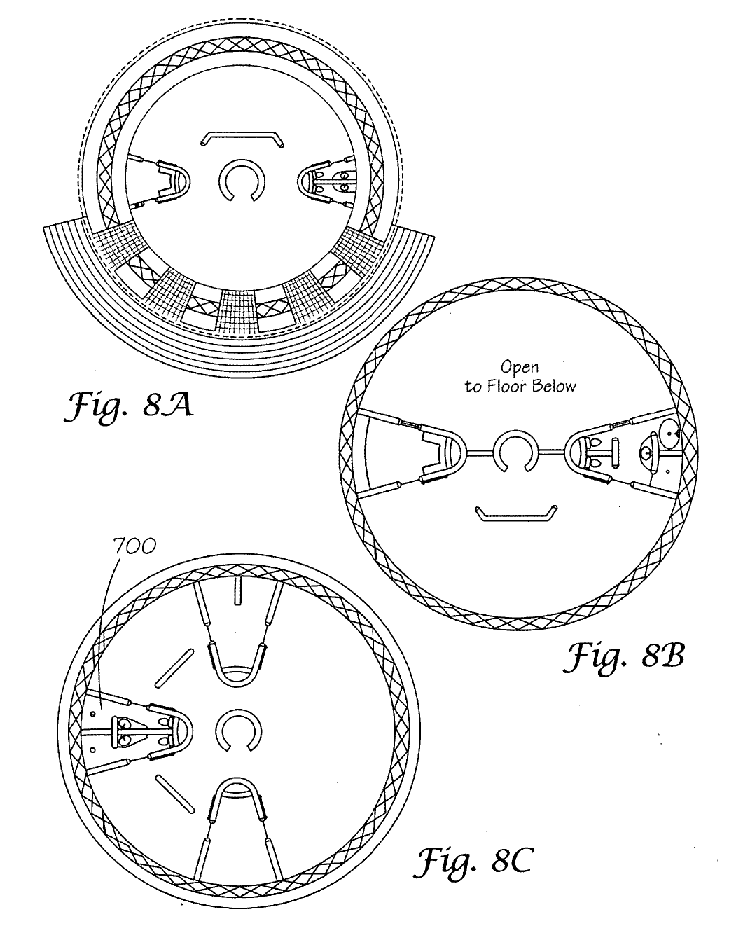

The structural support 100, the floor members 200 and the wall members 300 all comprise of a plurality of nucleus joint 110 and rod 120 systems, the “first set” of nucleus joint 110 and rod 120 systems, as seen in FIGS. 4A-C. It is envisioned that each nucleus joint 110 might be substantially spherical in shape and comprise of at least one threaded female receiver 112 as shown in FIG. 5. It is further envisioned that each rod 120 might be substantially cylinder shaped and comprise of at least one threaded male end 122 sized and configured to removably attach to the female receiver 112 of the nucleus joint 110 as shown in FIGS. 6A-C. It is envisioned that the dimensions of the nucleus joints 110 the dimensions of the rods 120 and the number of threaded female receivers 112 on the nucleus joint 110 might vary depending on the portion of the dwelling unit 10 the nucleus joint 110 or rod 120 is used in connection with. It is envisioned that a single nucleus joint 110 may have a plurality of rods 120 removably attached thereto as seen in FIG. 7. It is further envisioned that the nucleus joints 110 and rods 120 might be composed of a strong light weight material such as ceramic, carbon fiber, stainless steel or a metallic compound having similar properties as stainless steel. It is further envisioned that the structural support 100 might be composed of a fire retardant material.

As seen in FIG. 4b, the nucleus joints 110 and rods 120 might be configured to form a structure known in the architectural field as a “space mesh” 130. The space mesh 130 configuration displaces force in such a manner as to provide an structural support that is capable of withstanding a load that is greater that the load that could be borne from its individual parts. Moreover, as the unions formed by the nucleus joints 110 and the rods 120 are designed with predetermined angles and inclination grades, the resulting structural support 100 is a sphere that evenly distributes its carrying load.

It is envisioned that the unions formed between the nucleus joints 110 and the rods 120 might be disassembled if one so desired simply by unscrewing the threaded male end 122 of the rod 120 from the female receiver 112 of the nucleus joint 110. As such, the assembly and disassembly of the unions formed between the nucleus joints 110 and the rods 120 do not require a specialized knowledge and virtually anyone can assemble or disassemble same.

The dismantable floor members 200 also comprise of a plurality of nucleus joint 110 and rod 120 systems, the “second set” of nucleus joint 110 and rod 120 systems, as seen in FIGS. 4A-C and described in more detail above. As seen in FIG. 1, the floor members 200 might be removably attached to the structural support 100. It is envisioned that each floor member 200 may be removably attached to the structural support 100 at a plurality of predetermined locations so as to create rooms of varying heights as desired by the user and thereby configuring the floor members 200 to a set of predetermined positions. It is envisioned that the floor members 200 might further comprise of removably attached floor coverings 210. Said floor coverings 210 might resemble traditional floor coverings such as the tile, wood, and carpet floor coverings used in the traditional construction industry.

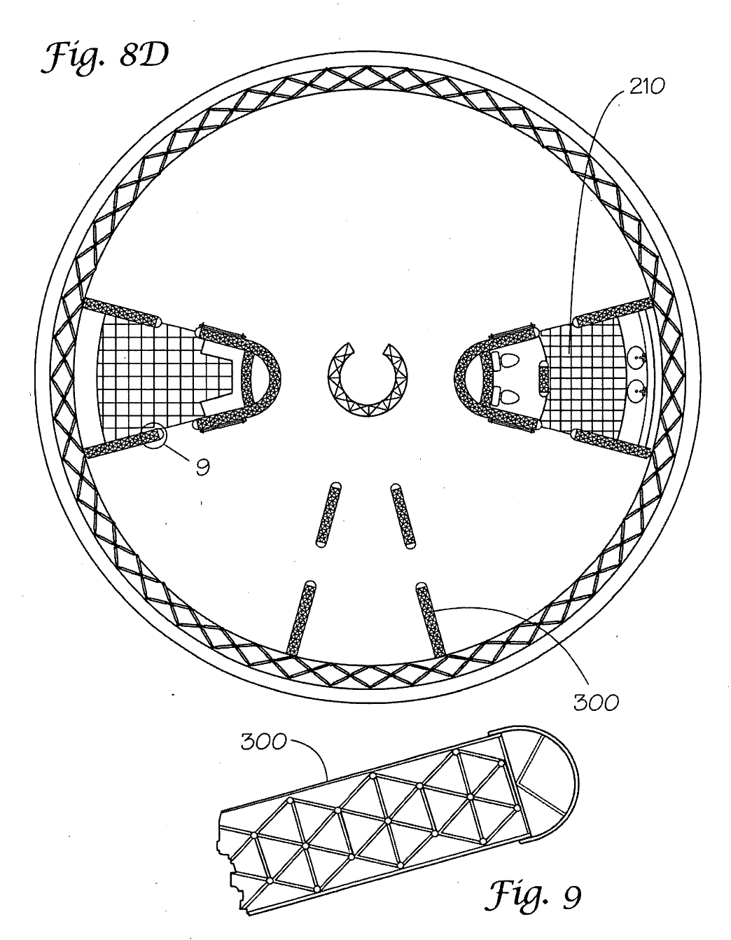

It is further envisioned that a plurality of interchangeable service units 700 might be removably attached to the floor members 200. As shown in FIGS. 8A-D the service units 700 might be configured to be used as bathrooms, closets, bedrooms, or other rooms of the dwelling unit 10.

The dismantable wall members 300 also comprise of a plurality of nucleus joint 110 and rod 120 systems, the “third set” of nucleus joint 110 and rod 120 systems, as seen in FIGS. 4A-C and described in more detail above. As seen in FIG. 8D, the wall members 300 might be removably attached to the structural support 100 and floor members 200. It is envisioned that each wall member 300 may be removable attached to the structural support 100 and floor members 200 at a plurality of predetermined locations so as to create rooms of varying sizes as desired by the user and thereby configuring the wall members 300 to a set of predetermined positions.

The central elevator shaft 400 and elevator means 410 might be located at the central axis of the dwelling unit 10. It is envisioned that the elevator means 410 might be operatively connected to the elevator shaft 400 so that the elevator means 410 may be used as transportation mode between the floor members 200 of the dwelling unit 10. In a preferred embodiment the elevator means 410 would be raised and lowered using hydraulic or pneumatic pressure.

It is further envisioned that the structural support 100 might be covered with a plurality of removably attached skin plates 140 to form the outer shell of the dwelling unit 10. In one embodiment of the dwelling unit 10, a plurality of power generating means 500 for generating electric power might be removably attached and operatively connected to the structural support 100. It is envisioned that the power generating means 500 might generate power using solar, wind, bio-fuels or other ecologically friendly methods of producing power. It is further envisioned that the dwelling unit 10 might comprise of a water accumulation and purification system 600 removably attached and operatively connected to the structural support 100. Although the present invention has been described as a dwelling unit, it is envisioned that one embodiment of the dwelling unit 10 might be used for commercial purposes. It is also envisioned that the dwelling unit 10 might be constructed for use in or underwater or in space.

The method of fabricating a dismantable, self sufficient, foundationless, partially subterranean, spherically shaped dwelling unit adapted for human dwelling involves first providing an area of land, then digging a semi-spherical hole in the land to a depth equal to one third of the height of the dwelling unit 10. The dwelling unit 10 is designed to be constructed without a foundation; however, it is envisioned that the semi-spherical hole will be sized and configured to snuggly hold the structural support 100 of the dwelling unit 10.

Then a plurality of nucleus joint 110 and rod 120 systems must be provided, whereby each nucleus joint 110 comprises of at least one threaded female receiver 112 and each rod 120 comprises of at least one threaded male end 122 sized and configured to removably attach to the female receiver 112 of the nucleus joint 110.

A dismantable spherical space mesh structural support 100 is constructed from the nucleus joint 110 and rod 120 systems and said structural support 100 is placed in said semi-spherical hole.

A plurality of dismantable floor members 200 comprising of said nucleus joint 110 and rod 120 systems are then erected, whereby each floor member 200 is removably attached to the structural support 100. Removably attachable floor coverings 210 are then installed to said dismantable floor members 200.

A plurality of dismantable wall members 300 comprising of said nucleus joint 110 and rod 120 systems are then erected, whereby each floor member 300 is removably attached to the structural support 100.

A central elevator shaft 400 is then erected, whereby the central elevator shaft 400 is removably attached to the structural support 100. An elevator means 410 for raising and lowering an elevator operatively connected to the central elevator shaft 400 is then installed and operatively connected to the central elevator shaft 400.

A plurality of power generating means 500 for generating electric power are then installed by removably attaching and operatively connecting the power generating means 500 to the structural support 100.

Finally, a water accumulation and purification system 600 is installed by removably attaching and operatively connecting the water accumulation and purification system 600 to the structural support 100.

An advantage of the present invention is that it provides a spherical dwelling unit comprised of a plurality of nucleus joint and rod systems.

Another advantage of the present invention is that it provides a spherical dwelling unit that can be constructed without a specialized knowledge in the field of construction.

Another advantage of the present invention is that it provides a spherical dwelling unit that is self sufficient and not dependant on exterior power and water supplies.

Another advantage of the present invention is that it provides a spherical dwelling unit that can be easily modified.

Yet, a further advantage of the present invention is that it provides a spherical dwelling unit that can be dismantled and then reassembled at a different location on a later date.

Although the present invention has been described in considerable detail with reference to certain preferred versions thereof, other versions are possible. Therefore, the spirit and the scope of the claims should not be limited to the description of the preferred versions contained herein.

What is claimed is:

1. A dismantable, self sufficient, foundationless, partially subterranean, spherically shaped dwelling unit adapted for human dwelling comprising:
a dismantable spherical space mesh structural support comprising of a first set of nucleus joint and rod systems, whereby each nucleus joint and rod system comprises of at least one nucleus joint comprising at least one threaded female receiver and at least one rod comprising of at least one threaded male end, sized and configured to removably attach to the female receiver of the nucleus joint;
a plurality of dismantable floor members comprising of a second set of nucleus joint and rod systems, whereby each nucleus joint and rod system comprises of at least one nucleus joint having at least one threaded female receiver and at least one rod having at least one threaded male end, sized and configured to removably attach to the female receiver of the nucleus joint, each floor member is removably attached to the structural support;
a plurality of dismantable wall members comprising of a third set of nucleus joint and rod systems, whereby each nucleus joint and rod system comprises of at least one nucleus joint having at least one threaded female receiver and at least one rod having at least one threaded male end, sized and configured to removably attach to the female receiver of the nucleus joint, each wall member is removably attached to the structural support;
a central elevator shaft removably attached to the structural support;
an elevator means for raising and lowering an elevator operatively connected to the central elevator shaft;
a plurality of power generating means for generating electric power removably attached and operatively connected to the structural support; and
a water accumulation and purification system removably attached and operatively connected to the structural support.

2. The dwelling unit of claim 1, wherein the wall members can be configured to as set of predetermined positions.

3. The dwelling unit of claim 2, wherein the floor members can be configured to a set of predetermined positions.

4. The dwelling unit of claim 3, wherein the wall members are removably attached to the floor members.

5. The dwelling unit of claim 4, wherein the floor members further comprise removably attached floor coverings.

6. The dwelling unit of claim 5, wherein the structural support is composed of a fire retardant material.

7. The dwelling unit of claim 1, further comprising a plurality of interchangeable service units removably attached to the floor members.

8. A method of fabricating a dismantable, self sufficient, foundationless, partially subterranean, spherically shaped dwelling unit adapted for human dwelling comprising:
providing an area of land;
digging a semi-spherical hole in the land to a depth equal to one third of the height of the dwelling unit;
providing a plurality of nucleus joint and rod systems, whereby each nucleus joint comprises of at least one threaded female receiver and each rod comprises of at least one threaded male end sized and configured to removably attach to the female receiver of the nucleus joint;
constructing a dismantable spherical space mesh structural support from the nucleus joint and rod systems and placing said structural support in said hole;
erecting a plurality of dismantable floor members comprising of said nucleus joint and rod systems, whereby each floor member is removably attached to the structural support;
erecting a plurality of dismantable wall members comprising of said nucleus joint and rod systems, whereby each floor member is removably attached to the structural support;
erecting a central elevator shaft removably attached to the structural support;
installing an elevator means for raising and lowering an elevator operatively connected to the central elevator shaft;
installing removably attachable floor coverings to said dismantable floor members;
installing a plurality of power generating means for generating electric power that are removably attached and operatively connected to the structural support; and
installing a water accumulation and purification system that is removably attached and operatively connected to the structural support.
